(19) United States
(12) Patent Application Publication
(10) Pub. No.: US 2006/0195584 A1
(43) Pub. Date: Aug. 31, 2006

(54) Call re-direction method for an sip telephone number of an sip client in a combined wired and packet switched network

(76) Inventor: Thomas Baumann, Holzkirchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/568,236

(22) PCT Filed: May 10, 2004
(86) PCT No.: PCT/EP04/50740

§ 371 Date: Feb. 14, 2006

(30) Foreign Application Priority Data
Aug. 14, 2003 (EP) 03018497.2

(51) Int. Cl. G06F 15/16

(52) U.S. Cl. 709/227

(57) ABSTRACT

When a specific numerical sequence and the SIP telephone number are entered on a telephone of any subscriber connection of switching equipment that is allocated to the communications network, the numerical sequence is evaluated in such a way that a first message containing the telephone number of the subscriber connection and the entered SIP telephone number is transmitted to a media gateway controller of the communications network. The controller transmits a second message containing the transmitted telephone number of the subscriber connection and the SIP telephone number to a SIP registrar, which saves the telephone number as the new current telephone number for calls to the SIP telephone number. Calls for the SIP telephone number are then re-directed to the current telephone number from the location service database.

### CROSS REFERENCE TO RELATED APPLICATIONS

This application is the U.S. National Stage of International Application No. PCT/EP2004/050740, filed May 10, 2004 and claims the benefit thereof. The International Application claims the benefits of European application No. 03018497.2 EP filed Aug. 14, 2003, both of the applications are incorporated by reference herein in their entirety.

### FIELD OF INVENTION

The present invention relates to call re-direction for an SIP telephone number of an SIP client in a combined wired and packet-switched network.

### BACKGROUND OF INVENTION

In modern communications networks a decomposition or separation of connection setup and medium or bearer setup is undertaken by the use of what are known as Media Gateway Controllers, abbreviated to MGC, and Media Gateways, abbreviated to MG. These enable Internet Protocol networks, abbreviated to IP networks, to be used as low-cost bearer technology.

FIG. 1 shows a typical example of an arrangement for application of this technology. FIG. 1 shows a Public Switched Telephone Network PSTN1 containing a number of Local Exchanges LE to which Telephones TE are connected in each case. The local exchanges are connected to a Terminal Exchange TX, which in its turn is connected to a first Media Gateway Controller MGC1 and a Media Gateway MG1. These two exchanges establish contact with each other via a first connection, over which the MGCP or H.248 protocol is used for communication. The Media Gateway Controller MGC1 is connected via a second connection to a second Media Gateway Controller MGC2, over which the controllers communicate through one of the protocols SIP T, BICC CS2 or ISUP+. The second Media Gateway Controller MGC2 is connected via a further connection to an SIP domain SIPD1. This consists of an SIP Proxy SIPP1, an SIP Registrar SIPR1 and a Location Service database LS1, which are interconnected. An SIP Client SIPC1 is connected to the SIP Proxy SIPP1 which also has a connection to the SIP Registrar SIPR1. The Media Gateway MG1 is also connected via an Internet Protocol network IP1 to the SIP Domain SIPD1.

The Session Initiation Protocol, abbreviated to SIP, in accordance with RFC2543/RFC3261, is increasingly used as the communication protocol for IP terminals. The protocols BICC CS2, ISUP+ or SIP T are used between Media Gateway Controllers.

The SIP protocol is based on a client-server architecture. This supports the mobility of SIP subscribers. An SIP client can be at any given location and register from there with what is known as an “SIP Registrar”. The “SIP Registrar” stores the SIP subscriber's registration information in a Location Service database. Through this registration it is possible for the SIP client, no matter where it is currently located, to be reached via its “global” SIP address or SIP telephone number. This is referred as the SIP mobility feature.

Gateways from the SIP network into the Public Switched Telephone Network, abbreviated to PSTN, have existed for some time now.

In the “classical” public telephone network there is the option of call re-direction to another subscriber connection in the public telephone network. In this case the call re-direction to another subscriber connection is configured at the subscriber connection concerned. On a change of location the subscriber connection redirecting the call must be re-administered. There is no provision for configuration of remote access.

### SUMMARY OF INVENTION

An object of the present invention is to make possible and to set up a call re-direction between SIP and PSTN networks.

This object is achieved by the features of the method in accordance with the independent claim.

The advantage of the invention lies in the fact that the inventive method, the interworking between PSTN and SIP network and the use of the SIP Mobility Feature makes a PSTN subscriber mobile. The subscriber can be thus can be at any location and can always be reached in the communication network under one and the same identifier, telephone number or call number. This telephone number could even be issued as a lifetime telephone number.

A further advantage lies in the fact no new administration has to be undertaken for a PSTN subscriber when they change their location, as was previously the usual case. In a similar way to a mobile radio terminal, one simply registers from the new location and can then be reached at the familiar telephone number. The solution described has the advantage over a mobile radio terminal of removing the need to have the terminal with you, but enabling any telephony terminal such as an ISDN telephone, analog telephone, PC, etc. to be used at any location such as in a hotel, in friends' houses, on holiday etc. to be used for registration.

The present invention has the further advantages, that:
it is simple, because it uses the existing SIP Mobility Features,
it is cheap since essentially only the Media Gateway Controller has to be adapted at the network interface to the SIP network,
it is universally applicable since a subscriber with an SIP telephone number can register from any PSTN telephone and can be reached on this telephone regardless of the connection technology used.

Interworking is possible with any solution which uses IP as its bearer technology, e.g.:
with a VoIP Trunking Subscriber,
with a VoDSL/VoCable subscriber, connected via an IAD/CPG/MTA,
with a subscriber connected via an access gateway, such as hiA7600,
with an H.323 subscriber,
with an SIP client.

Advantageous developments of the invention are specified in the subclaims.

In a development of the invention an authentication of the subscriber is undertaken. This has the particular advantage of avoiding an unauthorized setup of a call re-direction.

### BRIEF DESCRIPTION OF THE DRAWINGS

An exemplary embodiment of the invention is explained in greater detail below with reference to the drawings.

The Figures show:

FIG. 1 an arrangement of a first combination of PSTN and SIP network.

FIG. 2 an arrangement of PSTN and SIP network for explaining the method in accordance with the invention.

FIG. 3 an arrangement in accordance with FIG. 2 with a first method state.

FIG. 4 an arrangement in accordance with FIG. 2 with a second method state.

FIG. 5 an arrangement in accordance with FIG. 2 with a third method state.

### DETAILED DESCRIPTION OF INVENTION

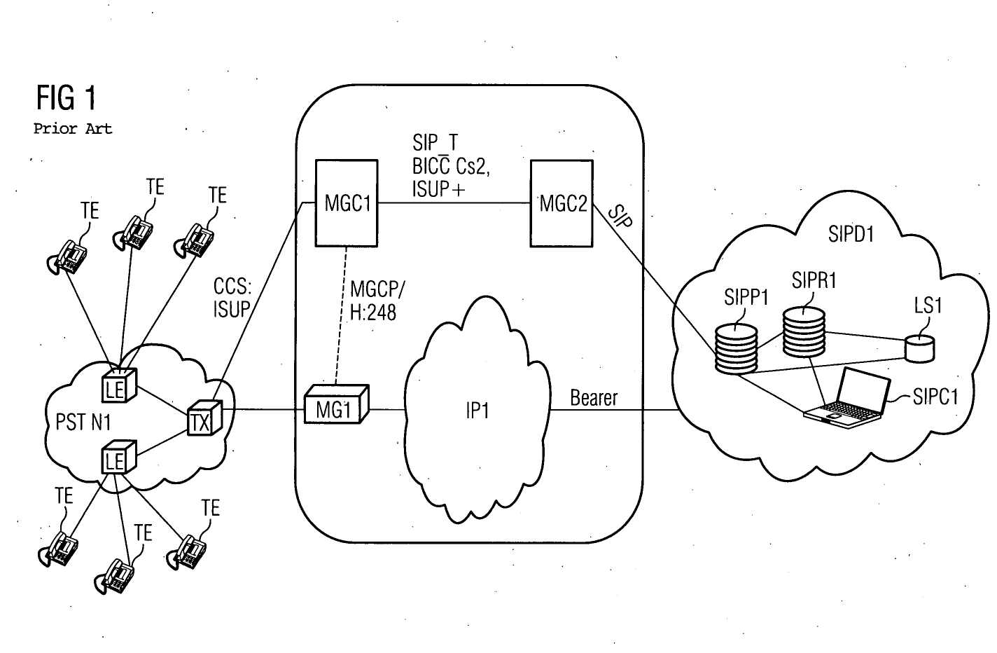

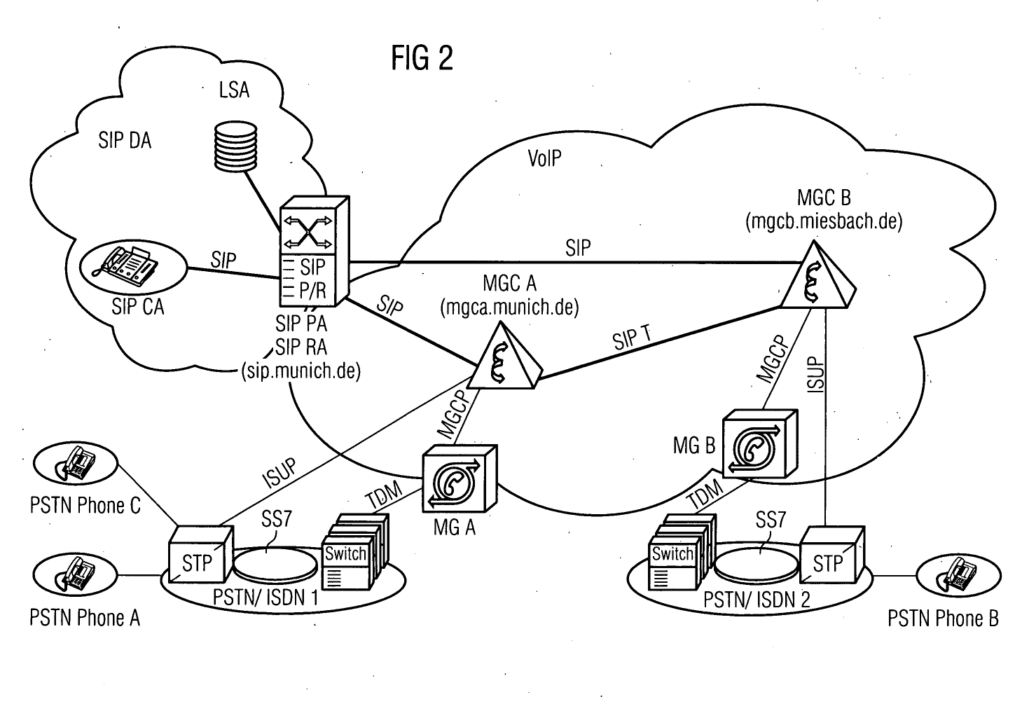

FIG. 1 shows an arrangement already described in the introduction of a combination of PSTN and SIP network. FIG. 2 shows a Voice-over-IP network VoIP, with two Media Gateway Controllers MGC A, with the assigned domain mgca.munich.de, and MGC B, with the assigned domain mgcb.miesbach.de These two Media Gateway Controllers communicate with each other by means of an IP connection through the SIP T protocol. The Media Gateway Controller MGC A further controls by means of an IP connection and by the Media Gateway Control Protocol, abbreviated to MGCP, a Media Gateway MG A. This Media Gateway MG A is connected via a Time Division Multiplex connection, abbreviated to TDM, to first “classical” PSTN switching equipment PSTN/ISDN1. This PSTN/ISDN1 switching equipment in its turn has a connection via the Signaling System 7, abbreviated to SS7, or ISDN User Part protocol, abbreviated to ISUP protocol, to the Media Gateway Controller MGC A. Two PSTN telephones PSTN Phone A and PSTN Phone C are connected to the first switching equipment PSTN/ISDN1 for example.

Connected to the Media Gateway Controller MGC B, as with Media Gateway Controller MGC A, is a Media Gateway MG B which is controlled via an IP connection and the Media Gateway Control Protocol, abbreviated to MGCP. Media Gateway MG B is connected via a TDM connection to a second “classical” switching equipment PSTN/ISDN2. This is again connected via an SS7 or ISUP protocol connection to the Media Gateway Controller MGC B. A PSTN telephone PSTN Phone B is typically connected to the second switching equipment PSTN/ISDN2.

The Media Gateway Controllers MGC A and MGC B each have an IP connection via which they communicate by means of the SIP protocol with an SIP Proxy SIP PA and an SIP Registrar SIP RA. The SIP Proxy SIP PA and the SIP Registrar SIP RA are located in this case on a server, but can also operate on separate servers. The SIP Proxy SIP PA and the SIP Registrar SIP RA each have a connection to a Location Service database LSA and for example an SIP Client SIP CA. The SIP Proxy SIP PA, the SIP Registrar SIP RA, the Location Service database LSA and the SIP Client SIP CA are located in an SIP Area SIP DA with the domain sip.munich.de.

A first subscriber is to be accessible via the SIP Client SIP CA with the SIP telephone number:

+49199462518 or 0049199462518.

In addition it is registered in the domain “sip.munich.de” at SIP Registrar SIP RA, so that the SIP number:

sip:+49199462518@sip.munich.de is produced.

In addition the first subscriber is to be accessible via the PSTN telephone PSTN Phone A with the telephone number:

+49 89 723467.

This telephone number is also registered in the domain of the Media Gateway Controller MGC A, mgca.munich.de. This produces an SIP number:

sip:+4989723467@mgca.munich.de

If the first subscriber is now on the PSTN telephone PSTN Phone B with the telephone number of subscriber access code:

+498024773377

and would like to accept calls to his SIP client SIP CA at PSTN telephone PSTN Phone B, the first subscriber dials from PSTN telephone PSTN Phone B a specific numerical sequence or identifier, such as #*21, and the SIP telephone number of his SIP client, that is:

*21 0049199462518.

The second PSTN switching equipment PSTN/ISDN2 detects the specific numerical sequence or identifier, evaluates this and the SIP telephone number and then sends an ISUP message, such as ISUP:IAM, with a special registration code, the SIP telephone number and telephone number of the subscriber connection at the Media Gateway Controller MGC B. The Media Gateway Controller MGC B evaluates this message and then sends an SIP:REGISTER message with the SIP telephone number, the SIP domain, the telephone number of the PSTN connection and its own SIP domain to the SIP Registrar SIP RA. i.e.

From: sip:+49199462518@sip.munich.de

Contact:<sip:+498024773377@mgcb.miesbach.de>

The SIP Registrar SIP RA stores the PSTN telephone number and the SIP domain of the Media Gateway Controller MGC B as new contact address for the specified SIP telephone number in the Location Service database and after successful storage sends an SIP:200 OK message to the Media Gateway Controller MGC B.

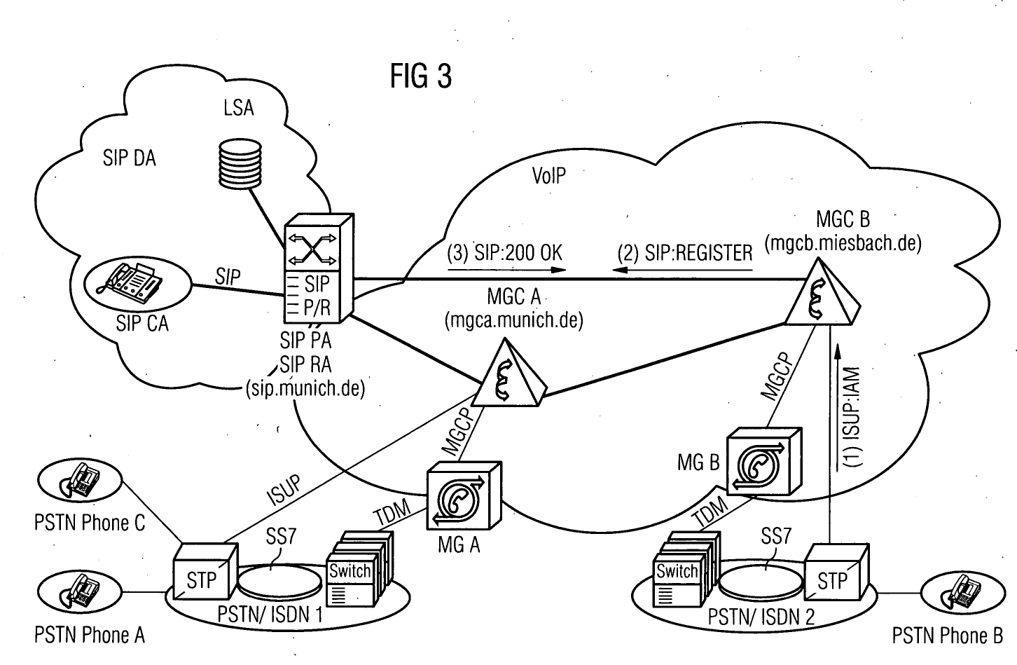

This process is shown schematically in FIG. 3. FIG. 3 shows an arrangement in accordance with FIG. 2, with the proviso that a first message (1) ISUP:IAM is sent from the second switching equipment PSTN/ISDN2 to the Media Gateway Controller MGC B, a second message (2) SIP:REGISTER from Media Gateway Controller MGC B to the SIP Registrar SIP RA and a third message (3) SIP:200 OK from the SIP Registrar SIP RA to the Media Gateway Controller MGC B.

If a second subscriber now wants to contact a first subscriber from an SIP client and dials the SIP telephone number of the first subscriber, an SIP:INVITE message is sent from the SIP client of the second subscriber to the SIP proxy SIP PA. Such as:

INVITE sip:+49199462518@sip.munich.de SIP/2.0

From: client02@sip.munich.de;tag=1c24841

To: sip:+49199462518@sip.munich.de

. . . .

The SIP proxy SIP PA now searches through the Location Service database LSA, to determine the current contact address or telephone number of the desired SIP telephone number. After determination of the current telephone number

498024773377@mgcb.miesbach.de

the SIP Proxy SIP PA modifies the SIP:INVITE message by entering the new telephone number, to:

INVITE sip:+498024773377@mgcb.miesbach.de SIP/2.0

From: client02@sip.munich.de;tag=1c24841

To: sip:+49199462518@sip.munich.de

. . . .

and sends this to the Media Gateway Controller MGC B. The Media Gateway Controller MGC B evaluates this message, detects the PSTN telephone number in the SIP:INVITE message and then sends an ISUP message to the second switching equipment PSTN/ISDN2. This evaluates the ISUP message and builds a call to the PSTN telephone PSTN Phone B.

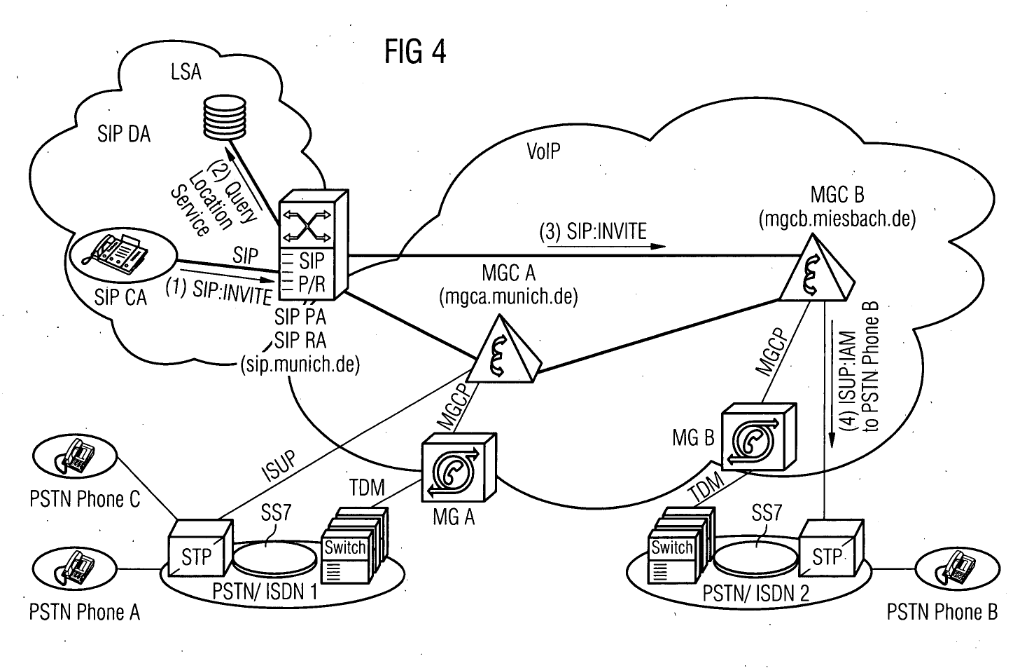

This sequence is shown schematically in FIG. 4. FIG. 4 shows an arrangement in accordance with FIG. 2, with the proviso that a message (1) SIP:INVITE is sent from the SIP client SIP CA to the SIP proxy SIP PA. This is evaluated there and a request (2) is sent by SIP Proxy SIP PA to the Location Service database. After a successful reply to the request a message (3) SIP:INVITE is sent from the SIP proxy SIP PA to the Media Gateway Controller MGC B which evaluates this message and sends a message (4) ISUP:IAM to the second switching equipment PSTN/ISDN2 which the issues/initiates a call to the/at the PSTN telephone PSTN Phone B.

For the case in which the first subscriber is called by a third subscriber from the PSTN network at the PSTN telephone PSTN Phone C with the telephone number:

+498972224996

which is located in the domain:

mgca.munich.de

the sequence described below is produced.

The third subscriber calls the SIP telephone number of the first subscriber from the PSTN telephone PSTN Phone C. The first switching equipment PSTN/ISDN1 then sends an ISUP message with the desired telephone number and the telephone number of the calling subscriber connection, that is of the PSTN telephone PSTN Phone C, to the Media Gateway Controller MGC A. The Media Gateway Controller MGC A evaluates this message and sends an SIP:INVITE message with the called and the calling telephone number to the SIP Proxy SIP PA. The domain of the desired SIP telephone number will be supplemented automatically in this case by the Media Gateway Controller. It can be permanently administered in the Media Gateway Controller or in the routing database of the Media Gateway Controller. Such as:

INVITE sip:+49199462518@sip.munich.de SIP/2.0

From: +498972224996@mgca.munich.de;tag=23d21

To: sip:+49199462518@sip.munich.de

. . . .

The SIP Proxy SIP PA evaluates this message and sends a request to the Location Service database LSA, in order to obtain the desired SIP telephone number or the current address or telephone number. After successfully determining the desired telephone number the SIP Proxy SIP PA modifies the SIP:INVITE message by entering the current telephone number of the desired SIP subscriber and sends it to the domain of the telephone number determined, that is to the Media Gateway Controller MGC B. For example:

INVITE sip:+498024773377@mgcb.miesbach.de SIP/2.0

From: +498972224996@mgca.munich.de;tag=23d21

To: sip:+49199462518@sip.munich.de

. . . .

The Media Gateway Controller MGC B evaluates the received message, detects the PSTN telephone number of its domain and sends an ISUP message to the second switching equipment PSTN/ISDN2. This evaluates the received ISUP message and sets up a call to the PSTN telephone PSTN Phone B.

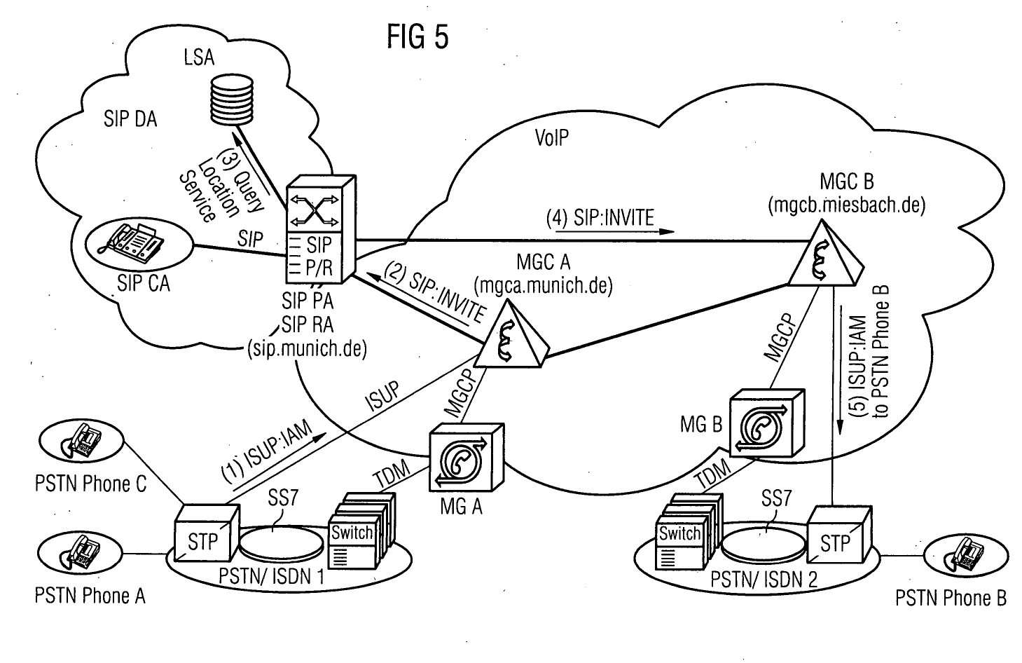

This sequence is shown schematically in FIG. 5. FIG. 5 shows an arrangement in accordance with FIG. 2, with the proviso that a message (1) ISUP:IAM is sent from the first switching equipment PSTN/ISDN1 to the Media Gateway Controller MGC A which evaluates this message and sends a message (2) SIP:INVITE to the SIP Proxy SIP PA. This creates a request (3) Query Location Service, which is sent to the Location Service database LSA. After a successful request and evaluation of the answer determined a message (4) SIP:INVITE is sent to the Media Gateway Controller MGC B by the SIP Proxy SIP PA. This evaluates the received message and creates a message (5) ISUP:IAM which is sent to the second switching equipment PSTN/ISDN2. This then sets up a call to PSTN telephone PSTN Phone B.

In an embodiment of the invention, after entry or dialing of the specific numerical sequence/identifier and the SIP telephone number and its transfer to the telephone switching equipment, an authentication of the subscriber is undertaken. This is done for example by requesting a password stored for the SIP telephone number or by a Personal Identification Number, abbreviated to PIN, and/or a transaction number, abbreviated to TAN, having to be entered. The request can be made in a similar manner to the way described above, by a request being sent from the switching equipment to the Media Gateway Controller and to the SIP Proxy Server. From this or from the Media Gateway Controller an authentication request can be submitted to a server, such as an (SIP) authentication server.

A PSTN subscriber has a “global” SIP telephone number under which he can always be reached, no matter where he is located. With this SIP telephone number and the call number of the “local” PSTN connection he registers with the SIP registrar.

If the “global” SIP telephone number is now called from an SIP client or PSTN connection, the call is re-directed via the SIP network to the current “local” PSTN telephone number. The PSTN subscriber can be reached via the “global” SIP telephone number at any given location.

1-7. (canceled)

8. A method for setting up a call re-direction for a SIP telephone number of a SIP client in a communication network, comprising:
detecting at a PSTN switching equipment, a sequence and a SIP telephone number entered at a PSTN subscriber telephone;
sending a first message having a telephone number of the PSTN subscriber telephone and the SIP telephone number, the first message sent from the PSTN to a Media Gateway Controller of the communications network;
sending a second message with the PSTN subscriber telephone number and the SIP telephone number, the second message sent from the Media Gateway Controller to a SIP Registrar of the communication network;
storing the PSTN subscriber telephone number in a Location Service database as a new contact address for the SIP telephone number;
determining the new contact address from the Location Service database for a call for the SIP telephone number; and
re-directing the call to the new contact address.

9. The method according to claim 8, wherein after the sequence is entered, a subscriber authentication is made.

10. The method according to claim 8, wherein the second message is a SIP:REGISTER message.

11. The method according to claim 8, wherein the first message is a ISUP:IAM message.

12. The method according to claim 11, wherein the second message is a SIP:REGISTER message.

13. The method according to claim 8, wherein after storing the PSTN subscriber telephone number in a Location Service database, a confirmation is sent to the Media Gateway Controller.

14. The method according to claim 13, wherein the confirmation is a SIP:200 OK message.

15. The method according to claim 8, wherein the PSTN subscriber telephone is connected to PSTN switching equipment via Voice-over-DSL, Voice-over-Cable or Voice-over IP trunking technology.

16. A method for setting up a call re-direction for a SIP telephone number of a SIP client in a communication network, comprising:
detecting at a PSTN switching equipment, a sequence and a SIP telephone number entered at a PSTN subscriber telephone;
sending a ISUP:IAM having a telephone number of the PSTN subscriber telephone and the SIP telephone number, the ISUP:IAM sent from the PSTN to a Media Gateway Controller of the communications network;
sending a SIP:REGISTER having the PSTN subscriber telephone number and the SIP telephone number, the SIP:REGISTER sent from the Media Gateway Controller to a SIP Registrar of the communication network;
storing the PSTN subscriber telephone number and a domain of the Media Gateway Controller associated with the PSTN subscriber telephone in a Location Service database as a new contact address for the SIP telephone number;
determining the new contact address from the Location Service database for a call to the SIP telephone number; and
re-directing the call by modifying a SIP:INVITE message to replace a invited number with the new contact address.

17. A method for setting up a call re-direction for a SIP telephone number of a SIP client in a communication network, comprising:
receiving from a Media Gateway Controller of a PSTN subscriber, a first message having a telephone number of the PSTN subscriber, a domain of the PSTN subscriber Media Gateway Controller, the SIP telephone number and a domain of the SIP telephone number;
storing the PSTN subscriber telephone number and the domain in a Location Service database as a new contact address for the SIP telephone number;
receiving an second message having the SIP telephone number as a telephone number being called and the SIP telephone number domain;
determining the new contact address from the Location Service database for the SIP telephone number;
re-directing the call by modifying the second message to replace an called number and SIP telephone number domain with the new contact address; and
sending the modified message toward the PSTN subscriber Media Gateway Controller.

18. The method according to claim 17, wherein the first message is a SIP:REGISTER message, the second message is a SIP:INVITE message, and the modified message is a SIP:INVITE.
